(19) United States
(12) Patent Application Publication
(10) Pub. No.: US 2023/0205830 A1
(43) Pub. Date: Jun. 29, 2023

(54) CUSTOMIZED INTERNET CONTENT DISTRIBUTION SYSTEM

(71) Applicant: Scalefast Inc., Wilmington, DE (US)

(72) Inventors: Nicolas LANNIER, El Segundo, CA (US); Frédéric BOCQUET, El Segundo, CA (US); Axel AMIGO ARNOLD, El Segundo, CA (US); Andrés TÉLLEZ SUÁREZ, El Segundo, CA (US)

(73) Assignee: Scalefast Inc., Wilmington, DE (US)

(21) Appl. No.: 17/575,718

(22) Filed: Jan. 14, 2022

(30) Foreign Application Priority Data
Dec. 24, 2021 (FR) 2114513

(51) Int. Cl. G06F 16/9535; G06F 16/957; G06F 16/958

(52) U.S. Cl. CPC G06F 16/9535; G06F 16/9577; G06F 16/958

(57) ABSTRACT

A customized Internet content distribution system comprises a storage of home web pages, wherein each web page is associated on the one hand to a segment identifier and on the other hand to a web page address, some of the web pages being associated to the same web page address such that each of these web pages defines a customized version of a generic web page associated to said same web page address, a web server arranged to receive a generic query for accessing a web page, said query being emitted from a device connected to the Internet, comprising a web page address fitted with a footprint of said device, to determine a segment identifier associated to said footprint, and to access said storage to obtain and send back to said device a web page associated to said web page address of the generic query and to said segment identifier.

### CROSS REFERENCE TO RELATED APPLICATION

The present application claims priority of French Patent Application No. 2114513 filed Dec. 24, 2021. The entire contents of which are hereby incorporated by reference.

### FIELD OF INVENTION

The invention relates to web servers and more particularly the supply of customized contents.

### BACKGROUND

Nowadays, it has become common to customize the contents of web sites according to the visitors. This customization makes the contents more attractive and generally improves the user experience.

Currently, there are two families of customization methods:
the methods based on prior identification, and
the agnostic methods.

In the case of identification-based methods, a visitor has an account on the web server that they visit, and the web server is therefore able to offer customized content for the user, since it knows who they are.

These methods based on prior identification lack flexibility and fluidity for the user. Indeed, a user should authenticate at first to have customized content, which alters their experience by adding a step that further requires them to retain or store an identifier and a password.

The second family of methods, namely that of agnostic methods, conventionally uses two types of solutions.

The first type of solutions consists in displaying a conventional web page, and then customizing it as soon as possible. In general, this customization is carried out either through an automatic reload that is not requested by the user, as soon as this user could be associated to a cluster of users, or through a customization of subsets of the page using a JavaScript code. The reload of the page is not compatible with a satisfactory user experience (UX) and it could even be perceived as a defect of the site. The use of JavaScript poses problems in keeping the code up-to-date, as well as the impossibility of implementation in secure environments, the execution of JavaScript being often blocked.

Furthermore, the fact that the user sees the customization being done before their eyes could make them be aware of this customization, and could give them the impression that the latter is artificial, and even intended to manipulate them. This considerably degrades the UX.

### SUMMARY

The invention is intended to improve the situation. To this end, it provides a customized Internet content distribution system comprising a storage of home web pages, wherein each web page is associated on the one hand to a segment identifier and on the other hand to a web page address, some of the web pages being associated to the same web page address such that each of these web pages defines a customized version of a generic web page associated to said same web page address, a web server arranged to receive a generic query for accessing a web page, said query being emitted from a device connected to the Internet, comprising a web page address fitted with a footprint of said device, to determine a segment identifier associated to said footprint, and to access said storage to obtain and send back to said device a web page associated to said web page address of the generic query and to said segment identifier.

This system is particularly advantageous because it allows offering a customization as of loading of the web page. In addition, since the user accesses a web page that is already customized, which is therefore more relevant, their UX is improved without them realizing it.

According to various embodiments, the invention may have one or more of the following features:
the web server comprises a reverse proxy arranged to query a database wherein each footprint is associated to a segment identifier,
the reverse proxy is a NGINX server,
the reverse proxy is a microservice,
the web server is arranged to receive a query for accessing a web page emitted by a user from a device connected to the Internet, devoid of a footprint of said device, and to generate said footprint and return it with a general version of said web page, and
the web server is arranged to receive a generic query for accessing a web page comprising a web page address fitted with a segment identifier and to access directly to access said storage with this access generic query.

The invention also relates to a method for distributing a customized Internet content comprising the following operations:
a) receive a generic query for accessing a web page, said query being emitted by a user from a device connected to the Internet, comprising a web page address fitted with a footprint of said device,
b) determine a segment identifier associated to said user from said footprint of said device,
c) access a storage of home web pages wherein each web page is associated on the one hand to a segment identifier and on the other hand to a web page address, some of the home web pages being associated to the same web page address such that each of these web pages defines a customized version of a generic web page associated to said same web page address, and recover a web page associated to said web page address of the generic query and to said segment identifier determined at the operation b), and
d) send back to said device the web page recovered at the operation c).

### BRIEF DESCRIPTION OF THE DRAWING

Other features and advantages of the invention will appear better upon reading the following description, from examples provided for illustrative and non-limiting purposes, from the drawings wherein:

FIG. 1 represents a high level diagram of a first embodiment of a customized Internet content distribution system.

### DETAILED DESCRIPTION

The drawings and the description hereinafter contain, for the most part, certain elements. Hence, they could not only serve to better understand the present invention, but also contribute to the definition thereof, where appropriate.

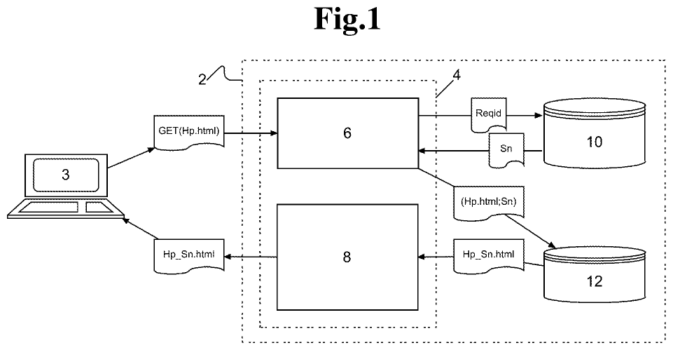

FIG. 1 represents a generic diagram of a customized Internet content distribution system 2 according to the invention. The customized Internet content distribution system 2 receives queries for access to web contents, in particular web pages of one or several device(s) 3 that are connected to the Internet.

In the example described herein, the customized Internet content distribution system 2 comprises one or several web server(s) 4 comprising a reverse proxy 6 and one or several server(s) 8, a database 10 associating query identifiers Reqid and segment identifiers SN, and a storage 12 which contains home web pages.

In the example described herein, the reverse proxy 6 and the server(s) 8 could be made in the form of a computer code or suitable program executed on one or several processor(s). By processors, it should be understood any processor suited for the computations described below. Such a processor could be made in any known manner, in the form of a microprocessor for a personal computer, a FPGA or SoC type dedicated chip, a computing resource on a grid or in the cloud, a cluster of graphical processors (GPUs), a microcontroller, or any other form adapted to provide the computing power necessary for the completion described below. One or more of these elements could also be made in the form of specialized electronic circuits such as an ASIC. A combination of a processor and of electronic circuits could also be considered. Processors dedicated for automatic learning could also be considered. The reverse proxy 6 and the server(s) 8 will be described in more details below and could be combined in the form of one single unit. Furthermore, they comprise means for communication through the Internet enabling them to receive Internet content queries from one or more of the devices 8, and to return to these this content if it is accessible thereto.

In the example described herein, the database 10 and the storage 12 could be implemented on any data storage type adapted to receive digital data: hard disk, SSD hard disk, flash memory in any form, random-access memory, magnetic disk, distributed storage locally or in the cloud, etc. The data computed by the system 2 could be stored on any memory type similar to the memory of the database 10 and of the storage 12, or on these. These data could be erased after the system 2 has completed its tasks or be preserved.

A conventional function of the web server 4 is to receive Internet content queries from the device 8 and to return this content to the latter. Conventionally, according to the http (or https) protocol, this is achieved through the emission of a GET query that contains the web address or Uniform Resource Locator (URL), to which a user of the device 8 wishes to access.

In the conventional web servers 4, it is not possible to customize a Web resource without the user being authenticated, i.e. they have opened an identification session in any form before the web server. It is this authentication that enables the web server to select customized contents for the user from the same generic web page address. By customized content, it should be understood for example the fact of displaying a page on which all or part of the content is modified, for example, according to the wishes and/or tastes and/or preferences and/or habits and/or location and/or language of the authenticated user. For example, on a sports news site, this could be achieved by highlighting the recent content relating to one or several team(s) that a user has indicated they prefer.

The customized Internet content distribution system 2 according to the invention is particular in that it enables a specific processing of the queries of home pages in the absence of an authentication of the user. Said otherwise, the customized Internet content distribution system 2 receives a generic query devoid of an identifier of the user, and is arranged to supply to this user a version of the web page that is suited to their wishes and/or tastes and/or preferences.

This is even more remarkable as the web page is a particular case where the web server does not have access to any information that could customize the user experience in the absence of authentication, while the web server could try implementing a customization for the other pages of a site, for example based on the route that has allowed access thereto from the web page.

For this purpose, the Applicant has discovered that it is advantageous to carry out a pre-processing of the query for access to the web page, even if this should delay loading thereof on the client side by a few milliseconds, in order to provide a pre-customized web page.

Thus, the web server 4 receives a query for accessing a web page Hp.html bearing the reference GET(Hp.html) in FIG. 1, and transmits it directly to a reverse proxy 6. The use of reverse proxies 6 is known per se primarily to achieve a load balancing for the web servers 4 comprising a large number of servers 8 allowing managing considerable flows of visitors.

In the embodiment described herein, the reverse proxy 6 is partially diverted from its original purpose in order to allow customizing the web page returned to the device 3. For this purpose, the reverse proxy 6 uses an identifier Reqid of the device 3. When it exists, this identifier is locally stored in a cookie on the device 3, and is transmitted to the web page 4 together with the query GET(Hp.html).

In the case where the device 3 does not contain an identifier Reqid, the latter is generated and stored for the next visit. In the example described herein, the identifier Reqid is generated by a packet fingerprint.js (https://fingerprintjs.com), which ensures obtaining a unique identifier for each device 3. Alternatively, other methods could be used to generate the identifier Reqid.

Based on the identifier Reqid, the reverse proxy 6 interrogates the database 10 in order to recover a segment identifier. The segment identifiers are used to select the customized content.

More specifically, the users of the devices 3 are grouped together according to their behavior. For example, they could be grouped together because they have visited a particular page before, or a succession of particular pages, or because their attitude has been similar (for example, setting of an item in a cart but no purchase, selection of particular information, etc.), etc.

Once this grouping is determined, a customized web page is defined for this group of users, also called segment. Finally, the database 10 is updated in order to associate on the one hand the identifiers Reqid and on the other hand the segment identifiers that correspond thereto.

Thus, when the reverse proxy 6 accesses the database 10, it recovers a segment identifier Sn that designates a group of users for which a particular customization has been provided.

In order to optimize the performances, the database 10 could advantageously be implemented in the form of a cache within the reverse proxy 6. Alternatively, it could be implemented in any other useful manner.

Afterwards, the reverse proxy 6 uses the web page—segment identifier pair to obtain the customized version of the web page Hp.html for the identifier segment Sn in the storage 12. In the example described herein, this is achieved by adding a suffix corresponding to the segment identifier Sn in the name of the web page. Other embodiments will be possible, like storage in repositories associated to the segment identifier, other naming conventions, etc.

In the example described herein, the reverse proxy 6 is a NGINX server. Alternatively, the reverse proxy 6 could be another reverse proxy, like a HAProxy or Traefik server. Still alternatively, the reverse proxy 6 could be a microservice, for example implemented by means of a lambda server of the Amazon Web Services company.

Alternatively, the device 3 could store the segment identifier Sn in the same manner as it stores the identifier Reqid once the latter has been determined. Thus, when the web server 4 receives a query for accessing the page Hp.html, the segment identifier Sn is transmitted like the other cookies, and the web server 4 could directly ask the storage 12 with the URL of the web page Hp.html and the segment identifier Sn in order to return the customized version.

Thus, the server 8 could return to the device 3 the page Hp_Sn.html that is the customized version of the page Hp.html for the identifier segment of the segment Sn associated to the device 3. Alternatively, rather than a full copy of the customized web page, the storage 12 could contain only the customization elements, the server 8 then being in charge of combining them with the generic version of the web page before sending it to the device 3.

Hence, the customized Internet content distribution system 2 allows supplying to the user of the device 3 a customized version of the web page of a site, without the user being authenticated, and without the latter being able to realize that a customization has been implemented between their query and the display of the web page on their screen. In the tests implemented by the Applicant, the latter has been able to verify that the implementation of the system 2 requires only 10 ms, which makes this execution time transparent for the user.

1. A customized Internet content distribution system comprising: a storage of home web pages, wherein each web page is associated on the one hand to a segment identifier and on the other hand to a web page address, some of the web pages being associated to the same web page address such that each of these web pages defines a customized version of a generic web page associated to said same web page address, a web server arranged to receive a generic query for accessing a web page, said query being emitted from a device connected to the Internet, comprising a web page address fitted with a footprint of said device, to determine a segment identifier associated to said footprint, and to access said storage to obtain and send back to said device a web page associated to said web page address of the generic query and to said segment identifier.

2. The customized Internet content distribution system according to claim 1, wherein the web server comprises a reverse proxy arranged to query a database wherein each footprint is associated to a segment identifier.

3. The customized Internet content distribution system according to claim 2, wherein the reverse proxy is a NGINX server.

4. The customized Internet content distribution system according to claim 2, wherein the reverse proxy is a microservice.

5. The system according to claim 1, wherein the web server is arranged to receive a query for accessing a web page emitted by a user from a device connected to the Internet, devoid of a footprint of said device, and to generate said footprint and return it with a general version of said web page.

6. The system according to claim 1, wherein the web server is arranged to receive a generic query for accessing a web page comprising a web page address fitted with a segment identifier and to directly access said storage with this access generic query.

7. A method for distributing a customized Internet content comprising the following operations:
a) receive a generic query for accessing a web page, said query being emitted by a user from a device connected to the Internet, comprising a web page address fitted with a footprint of said device,
b) determine a segment identifier associated to said user from said footprint of said device,
c) access a storage of home web pages wherein each web page is associated on the one hand to a segment identifier and on the other hand to a web page address, some of the home web pages being associated to the same web page address such that each of these web pages defines a customized version of a generic web page associated to said same web page address, and recover a web page associated to said web page address of the generic query and to said segment identifier determined at the operation b), and
d) send back to said device the web page recovered at the operation c).
